(19) United States
(12) Patent Application Publication
(10) Pub. No.: US 2024/0333889 A1
(43) Pub. Date: Oct. 3, 2024

(54) PATTERN PROJECTION AND DETECTION USING FLAT OPTICS

(71) Applicant: 2Pi Inc., Cambridge, MA (US)

(72) Inventors: Tian Gu, Acton, MA (US); Juejun Hu, Newton, MA (US); Xiaochen Sun, Chino Hills, CA (US); Hung-I Lin, Cambridge, MA (US); Fan Yang, Cambridge, MA (US)

(73) Assignee: 2Pi Inc., Cambridge, MA (US)

(21) Appl. No.: 18/622,835

(22) Filed: Mar. 29, 2024

Related U.S. Application Data
(60) Provisional application No. 63/493,004, filed on Mar. 30, 2023.

(51) Int. Cl. H04N 9/31

(52) U.S. Cl. CPC H04N 9/3164; H04N 9/3155; H04N 9/3161

(57) ABSTRACT

An optical pattern projection device includes a light emitter or light emitter array and one or more flat optics layers configured to project and split light beams from the light emitters to generate a projected light pattern including multiple sub-patterns each corresponding to one of the light emitters. The flat optics layers may include a single optical metasurface containing superposed beam shaping and/or projection phase profile and a beam splitting phase profile. Alternatively, the flat optics layers may include two optical metasurfaces each containing a light shaping and/or projection phase profile, which together produce a linear relationship between light emitter position and corresponding beam projection angle, and one or both of the metasurfaces further contains a superposed beam splitting phase profile. The light shaping and/or projection phase profile may have a function similar to a micro-lens array. A structured light camera combining optical pattern projection and detection is also provided.

### BACKGROUND OF THE INVENTION

The present invention is related to flat optics and their applications in optical and photonic systems.

Optical pattern generation and detection capture changes in light intensity, phase, or polarization of an illuminated scene, which is essential to applications such as 3-D sensing, medical imaging, automation, illumination, display, Lidar (Light Detection and Ranging), optical computing, environmental monitoring, etc. State-of-the-art pattern generation optical systems are typically based on refractive and/or diffractive optical elements (DOE) for light shaping and projection. Such traditional optical approaches usually result in complicated, multiple-element assemblies with non-optimal pattern quality, limited field-of-view (less than) 90°, poor efficiency, and bulky form factors.

US 20210044748 describes an optical system (see FIGS. 13A and 13B) where meta-lenses are used to modulate beams emitted a light emitter array to generate 2-D or 3-D optical patterns, dot arrays or clouds, images, hologram, or patterns with different polarization and/or spectral properties.

### SUMMARY OF THE INVENTION

The present invention is directed to a flat optics-based optical pattern generation architecture that substantially obviates one or more of the problems due to limitations and disadvantages of the related art.

Embodiments of the present invention provide light projection, pattern generation and detection architectures using metasurface flat optics. These architectures offer high performance, small form factor and multifunctions as compared to traditional optical approaches. The optical architectures can be used in a variety of optical systems including sensing, structured light imaging, illumination, display, Lidar, computing, etc.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve the above objects, the present invention provides an optical pattern projection device, which includes: one or more light emitters; and a first optical metasurface coupled to the one or more light emitters, configured to project, reshape and/or split light beams generated by the one or more light emitters to generate a projected light pattern, the first metasurface layer containing at least two superposed phase profiles, performing different functions from each other, each of the at least two phase profiles being configured to modulate, collimate, focus, diverge, deflect, shape, split, diffract, or diffuse the light beams from the one or more light emitters.

In some embodiments, at least one of the at least two superposed phase profiles is configured to split or diffract light so as to spatially or angularly distribute the light beam from each of the one or more light emitters into multiple channels.

The device may further include a second optical metasurface spaced apart from the first optical metasurface, the second optical metasurface containing a light shaping and/or projection phase profile configured to collimate, focus, and/or deflect the light beams from the one or more light emitters, wherein the first and second optical metasurfaces cooperate with each other to produces a defined relationship between light emitter position or light property and corresponding beam projection angle. In some embodiments, the defined relationship is a linear relationship between light emitter position and beam projection angle.

In another aspect, the present invention provides an optical pattern projection device, which includes: a light emitter array including a plurality of light emitters; and one or more flat optics layers, configured to project and split light beams generated by the plurality of light emitters to generate a projected light pattern, the projected light pattern including a plurality of sub-patterns each corresponding to one of the light emitters, wherein the sub-patterns are identical in shape, are shifted in position relative to each other, and overlap each other.

In another aspect, the present invention provides an optical pattern projection device, which includes: a light emitter array including a plurality of light emitters; and a flat optics layer coupled to the light emitter array, configured to project, reshape and/or split light beams generated by the plurality of light emitters to generate a projected light pattern, the projected light pattern including a plurality of sub-patterns each corresponding to one of the light emitters, wherein the flat optics layer includes superposed phase profiles, including a phase profile for beam collimation and projection in which different regions of the flat optics are configured for coupling light beams from different light emitters, and a beam splitting phase profile configured to spatially distribute the light beam from each light emitter into multiple channels.

In another aspect, the present invention provides an optical pattern projection device, which includes: one light emitter or a light emitter array including a plurality of light emitters; and a single flat optics layer coupled to the light emitter or light emitter array, configured to project, reshape and/or split light beams generated by the light emitter or plurality of light emitters to generate a projected light pattern.

In another aspect, the present invention provides an optical pattern projection device, which includes: one light emitter or a light emitter array including a plurality of light emitters; and two flat optics layers spaced apart from each other and having identical sizes, configured to project, reshape and/or split light beams generated by the light emitter or plurality of light emitters to generate a projected light pattern, the projected light pattern including a plurality of sub-patterns each corresponding to one of the light emitters.

In another aspect, the present invention provides an optical pattern projection device, which includes: one light emitter or a light emitter array including a plurality of light emitters; and two optical metasurfaces spaced apart from each other, configured to project, reshape and/or split light beams generated by the light emitter or plurality of light emitters to generate a projected light pattern, the projected light pattern including a plurality of sub-patterns each corresponding to one of the light emitters, wherein each of the two optical metasurfaces contains a light shaping, projection and/or splitting phase profile configured to collimate, focus, and/or deflect the light beams from the light emitter or plurality of light emitters, wherein the two optical metasurfaces cooperate with each other to produces a defined relationship between light emitter position or the light property and beam projection angle, and wherein at least one of the two optical metasurfaces further contains a superposed beam splitting phase profile configured to spatially distribute the light beam from each light emitter into multiple channels.

In another aspect, the present invention provides an optical pattern projection and detection device which includes any of the above optical pattern projection devices, further including an optical pattern detection device which includes: another optical metasurface; and a light receiver coupled to the other optical metasurface.

It is to be understood that both the foregoing general description and the following detailed description are exemplary and explanatory and are intended to provide further explanation of the invention as claimed.

### BRIEF DESCRIPTION OF DRAWINGS

FIGS. 1A-1B schematically illustrate two examples of an optical pattern generation architecture using flat optics according to embodiments of the present invention.

FIGS. 1C-1E illustrate three examples of light patterns generated by an optical pattern generation architecture according to embodiments of the present invention.

FIGS. 2A-2D illustrate an exemplary optical pattern generation architecture according to an embodiment of the present invention, which generates a light pattern similar to that shown in FIG. 1C.

FIGS. 3A-4E show the light emitter array and dot projection properties of an optical pattern generation architecture similar to that shown in FIGS. 2A-2D.

FIGS. 4A-4E show the light emitter array and dot projection properties of another optical pattern generation architecture similar to that shown in FIGS. 2A-2D.

FIGS. 5A-5D illustrate an exemplary optical pattern generation architecture according to an embodiment of the present invention, which generates a light pattern similar to that shown in FIG. 1D.

FIGS. 6A-6E show the light emitter array and dot projection properties of another optical pattern generation architecture similar to that shown in FIGS. 5A-5D.

FIGS. 7A-7B illustrate exemplary optical pattern generation architectures according to other embodiments of the present invention.

FIG. 8 schematically illustrates a structured light camera combining a flat optics-based pattern projector and a flat optics-based imager according to an embodiment of the present invention.

FIG. 9A-9D schematically illustrates the design of multi-layer flat optics architectures according to an embodiment of the present invention.

FIG. 10A schematically illustrates multi-layer flat optics architectures according to another embodiment of the present invention. FIGS. 10B and 10C show the light distribution produced by the structure of FIG. 10A and by a single-layer flat optics, respectively.

### DETAILED DESCRIPTION OF THE INVENTION

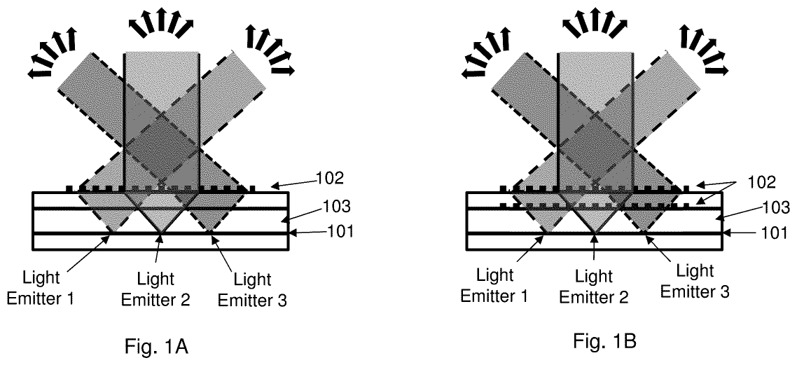

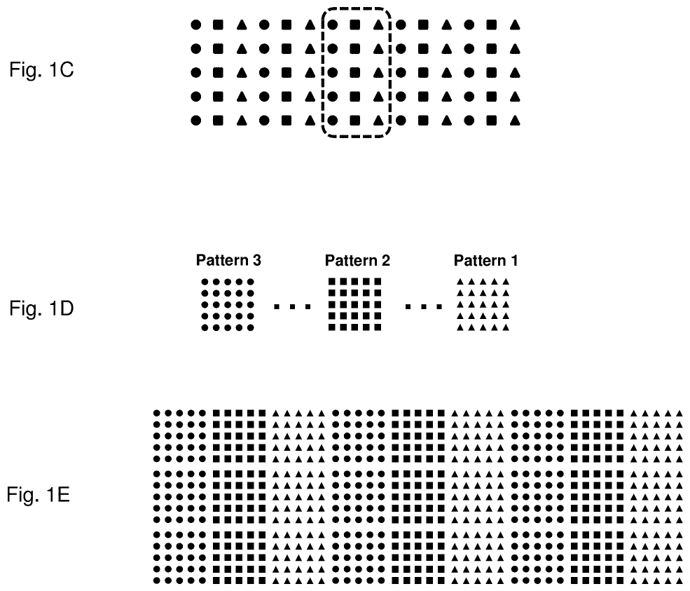

Embodiments of the present invention provide pattern projection and detection optical architectures, systems and designs using flat optics (e.g., metasurface optics, metamaterials, sub-wavelength optics, etc.). As schematically illustrated in FIGS. 1A and 1B, an exemplary pattern generation system includes the following components: a light emitter array 101 containing one or more light emitters and one or multiple flat optics components (FO) 102 coupled to the light emitter array. The flat optics 102 (either a single or multiple elements) is designed to provide beam projection, shaping, splitting, and/or deflection functionalities. The flat optics 102 may modulate the phase, intensity, and/or polarization of the beam or beam arrays emitted by the light emitter array 101.

For example, the flat optics 102 may be a metasurface that contains superposed phase profiles including light shaping and/or projection and beam splitting functions to generate desired patterns. The light shaping and/or projection phase profile may be designed to collimate, focus, and/or deflect the light from the light emitters (e.g., generating a dot array or pattern from the light emitter array), or provide other wavefront modulation functions. The beam splitting phase profile further functions to spatially distribute the projected light into multiple channels, e.g., generating multiple dot arrays, or multiple projected patterns. In other examples, the metasurface 102 contains two or more superposed phase profiles, performing different functions from each other, each phase profile being configured to modulate, collimate, focus, diverge, deflect, shape, split, diffract, diffuse, or otherwise modulate the light from the light emitter array 101.

The pattern generation optical systems may produce any 2-D or 3-D patterns, including, but not limited to arrays of dots, lines, matrices, letters, graphics, holograms, random patterns, gray-scale patterns, uniform patterns, diffusive patterns, etc. Thus, they can be utilized for projectors, illuminators, diffusers, etc. The light shaping and/or projection (e.g., functioning as a lens) and beam splitting phase profiles may be superposed on the same flat optics layer (FIG. 1A) or on separate flat optics layers (FIG. 1B). Additionally, the superposed phase profiles may be configured to function the same or differently, depending on the properties of the incident light (e.g., wavelength, polarization, angle-of-incidence, etc.). The flat optics 102 may be configured to provide different responses for different properties of light.

The flat optics component 102 may be a metasurface containing one or multiple superposed phase profiles. As an example, the flat optics component may be a metasurface containing a lens phase profile or superposed phase profiles of a lens and a beam splitter. The lens phase profile may collimate and/or reshape and project the light from the light emitter array 101. The beam splitter phase profile further distributes the projected pattern into multiple channels; or makes multiple duplications of the projected pattern and deflects them towards different directions. The beam splitter phase profile may contain sub-regions with different k-vectors (e.g., k-vectors parallel to the flat optics plane, or in-plane phase gradient patterns) that distribute the incident light beams and deflect them towards different directions. It may contain a phase profile similar to the phase of a prism and/or grating array in which each prism and/or grating deflects a portion of the incident light towards a different direction (channel). It may also be in the form similar to a grating that diffracts the incident light into different orders. The metasurface may be designed to control the power distribution across various diffraction orders.

The metasurface 102 may also be designed to be sensitive to different properties of the incident light (e.g., polarization, wavelength, incident angle, etc.) so that light with different properties will be modulated differently, e.g., be redirected to different directions (channels), thereby functioning as a beam splitter, diffuser or distributor. Additional beam splitting or pattern generation phase profiles may be applied to each or all split channels to create additional sub-channels.

One embodiment of the lens phase profile is a quadratic phase profile. In other examples, the lens phase profile may also be defined as polynomial expansions of spatial coordinates, a freeform phase profile, non-continuous phase profiles, segmented phase profiles, superposed phase profiles, or in other forms. One or more metasurfaces or lens profiles may be used. The phase profiles may be designed to control or improve the performance of the optical system, such as imaging and/or projection quality, resolution, field of view (FOV), depth-of-field, angle of incidence (AOI)—image height relation, distortion, relative illumination, uniformity, efficiency, etc.

More generally, the flat optics 102 may include, without limitation, sub-wavelength optics, metasurfaces, multi-layer metasurfaces, metamaterials, diffractive optical elements (DOE, e.g., binary, multi-level, or grayscale DOEs, etc.), holographic optical elements (HOE), wafer level optics (WLO), micro-optics, etc., or a combination of these components. One embodiment of the flat optics is optical metasurfaces. Optical metasurfaces, also alternatively termed sub-wavelength diffractive optics, are artificial media comprising 2-D arrays of sub-wavelength optical structures (commonly called meta-atoms), typically positioned on a substrate. The meta-atoms and the substrate may be made of the same or different optical materials. The meta-atoms are designed to change the phase, amplitude, and/or polarization of incident light. The meta-atoms may have the same or different geometries, dimensions, and orientations. Exemplary geometries may include rectangular, cylindrical, freeform, or any other suitable shapes or combinations of different shapes, etc. The lattice of the meta-atoms may have any suitable shape and period (e.g., square, rectangular, or hexagonal). The lattice may also be aperiodic, with varying or random distances between adjacent meta-atoms. In some examples, the gap between adjacent meta-atoms may be designed to have a constant gap distance.

The metasurface 102 may be flat, curved or conformally integrated with its substrate. One or both sides of the substrate may be flat or curved. Both the metasurface and the substrate may be rigid, flexible, or stretchable. The geometries, dimensions, and layout of the meta-atoms and substrate are designed to provide the target optical functions. The metasurfaces may be designed to operate at a single wavelength, multiple wavelengths, or over a continuous spectral range. The metasurface may be designed to provide different functions depending on the properties of the incident light (e.g., polarization, wavelength, incident angle, intensity, etc.). With proper configuration and materials, the metasurface may be designed for all optical wavelengths (e.g., UV, visible, near-infrared, mid-infrared, long wave infrared, etc.). The metasurface may be immersed in another optical material. Additional elements (one or an array of them) may also be included to modulate the light, e.g., filters (e.g., spectral, polarization, spatial, and/or angular filters), refractive and/or diffractive and/or reflective optical elements, light modulators, liquid crystal elements, etc.

A spacer 103 made of air, glass, polymer, semiconductors, or other optical materials may be positioned between the flat optics component 102 and the light emitter array 101. The light emitter array 101, the flat optics component 102, and the spacer 103 (if present) may be mechanically coupled to each other using any suitable structure such as adhesives.

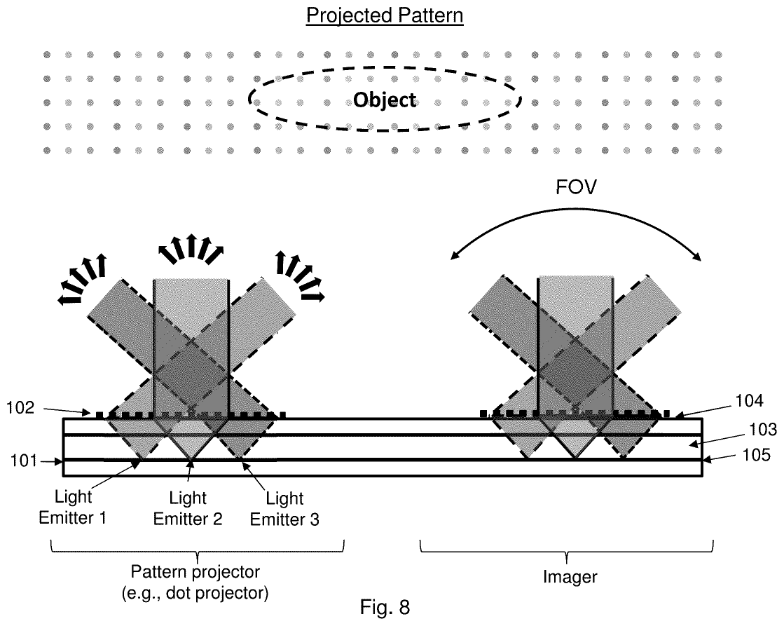

The flat optics architectures and designs described in this disclosure can be used for both light projection (when coupled with light emitters) and detection (when coupled with detectors or receivers) (see FIG. 8, described in more detail later). When used for light projection, the light emitters 101 may include one or multiple light sources (e.g., lasers, light emitting diodes (LEDs)), and/or optical channels (e.g., fibers, waveguides, optical couplers, etc.). When used for light detection, the receivers may include one or multiple photodetectors, and/or optical channels (e.g., fibers, waveguides, optical couplers, etc.). In addition to physical objects, the light emitters (more generally referred to as light transmitters) and receivers may also be non-physical, such as images and/or light patterns generated, or received by other optical components or systems, respectively. The light emitter array may include emitters configured to emit light with the same or different properties, e.g., wavelength, polarization, beam divergence, orders, or other beam properties. Additional elements (one or an array of them) may also be included to modulate the emitted light, e.g., filters (e.g., spectral, polarization, spatial, and/or angular filters), refractive and/or diffractive and/or reflective optical elements, light modulators, liquid crystal elements, etc. One example is a pixelated spectral filter array or a single filter coupled with the light emitter array. Another example is a pixelated polarization filter array or a single filter coupled with the light emitter array.

The emitters may have the same or different geometries, dimensions, and orientations. Exemplary geometries may include circular, square, rectangular, freeform, or any other suitable shapes or combinations of different shapes, etc. The positions of the emitters may have any suitable layout and spacing (e.g., square, rectangular, or hexagonal). The spacing may also be aperiodic, with varying or random distances between adjacent emitters. The emitters may be positioned on a planar or non-planer surface.

FIGS. 1C-1E illustrate three examples of light patterns that may be generated by the optical pattern generation architecture of FIGS. 1A and 1B. Each light pattern includes multiple sub-patterns, each sub-pattern being generated by light from one of the array of light emitters. Note here that the circle, square and triangle symbols in these drawings are used to represent the different sub-patterns, and do not represent the shape of the projected light spots. The sub-patterns are identical in shape and are shifted in positions relative to each other. The sub-patterns may overlap each other (e.g., FIGS. 1C, 1E) or may be non-overlapping with each other (e.g., FIG. 1D). In the light pattern shown in FIG. 1C, light spots formed by the three light emitters include interleaved dot columns; more specifically, in this example, the 1st, 4th, 7th, . . . columns are formed by the third light emitter, the 2nd, 5th, 8th, . . . columns are formed by the second light emitter, and the 3rd, 6th, 9th, . . . columns are formed by the first light emitter. In the light pattern shown in FIG. 1D, light spots formed by the three light emitters include three spatially separated dot arrays, each formed by one of the three light emitters. In the light pattern shown in FIG. 1E, light spots formed by the three light emitters include interleaved multi-column blocks; more specifically, in this example, the 1st, 4th, 7th, . . . three-column blocks are formed by the third light emitter, the 2nd, 5th, 8th, . . . three-column blocks are formed by the second light emitter, and the 3rd, 6th, 9th, . . . three-column blocks are formed by the first light emitter.

Examples of the optical pattern generation architecture according to embodiments of the present invention are described in more detail below.

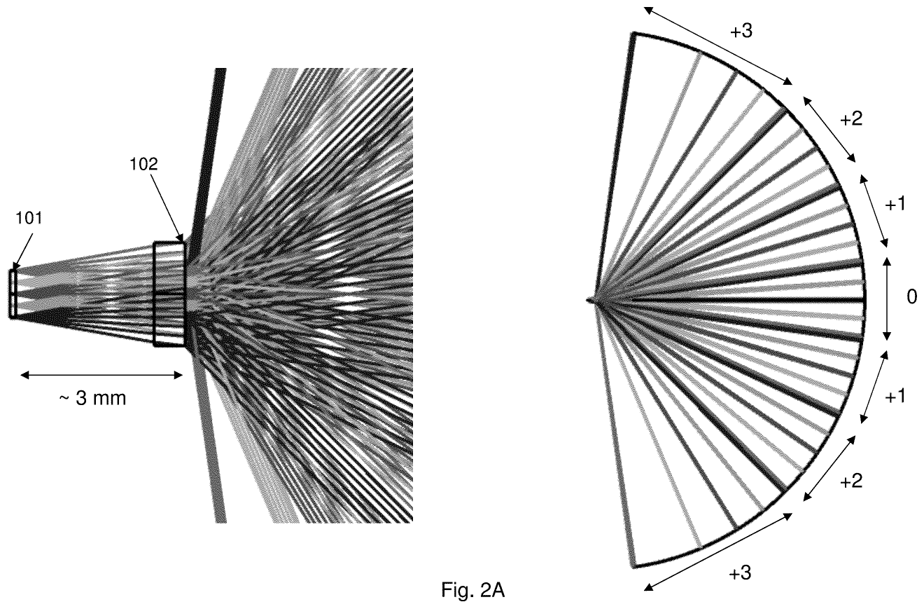

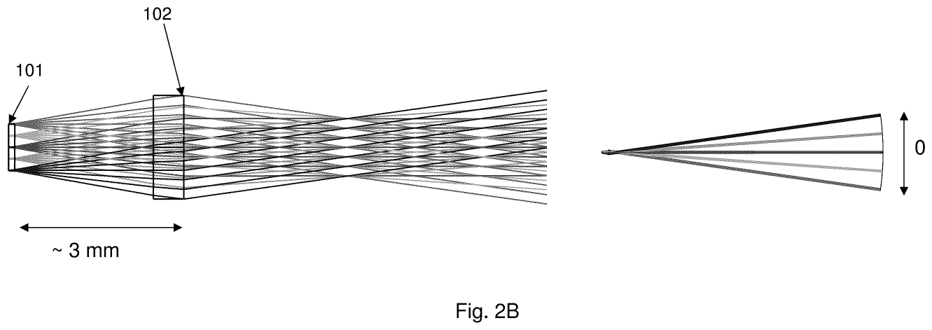

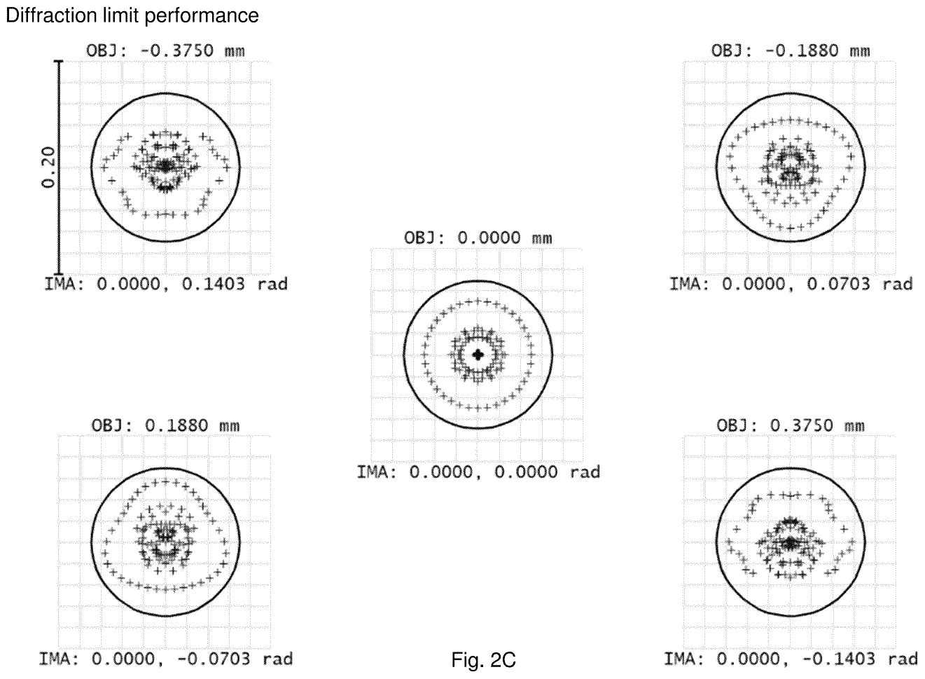

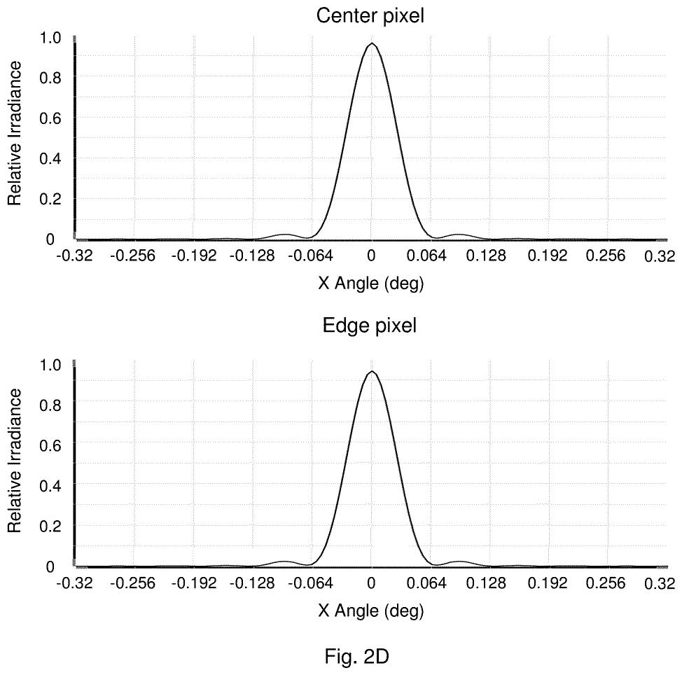

In one example (FIGS. 2A-2D), the flat optics (e.g., a metasurface) contains superposed phase profiles of a lens (for beam collimation and/or projection) and a beam splitter to generate interleaved spot array patterns similar to that shown in FIG. 1C. FIG. 2A shows the raytrace simulation of such a flat-optics-enabled ultra-compact pattern generation system design. The flat optics component collimates and projects the light from the light emitters towards different directions and further splits each beam into multiple channels (seven in this example, labeled 0 to +3), producing high-density, high quality spot projection. FIG. 2B shows the raytrace simulation of a single channel (channel 0) (also note that the dashed line rectangle in FIG. 1C indicates channel 0). Note that in FIGS. 2A and 2B, the most counter-clockwise ray within each channel corresponds to the light emitter at the lower end of the light emitter array 101 of FIG. 2A. FIGS. 2C and 2D show the simulation results indicating diffraction limited beam quality of the collimated beams emitted from the light emitter arrays. The divergence angle is less than 0.13 degrees in this example. In this example, the system's design wavelength is 940 nm, but other wavelengths may also be chosen.

This optical system may be configured to realize different beam shaping functions, e.g., collimation, focusing, diverging, or other desired intensity and/or phase distributions of the projected pattern (e.g., dots, lines, matrix, graphics, letters, holograms, random patterns, gray-scale patterns, uniform patterns, diffusive patterns, etc.). The projected optical pattern may be further engineered by controlling the positions or arrangement of the light emitter array, as well as their optical properties (e.g., polarization, wavelength, incident angle, etc.). Additional optical elements (e.g., a flat optics, refractive/reflective optics, micro-lens array, etc.) may be incorporated to further vary the performance and/or functionality.

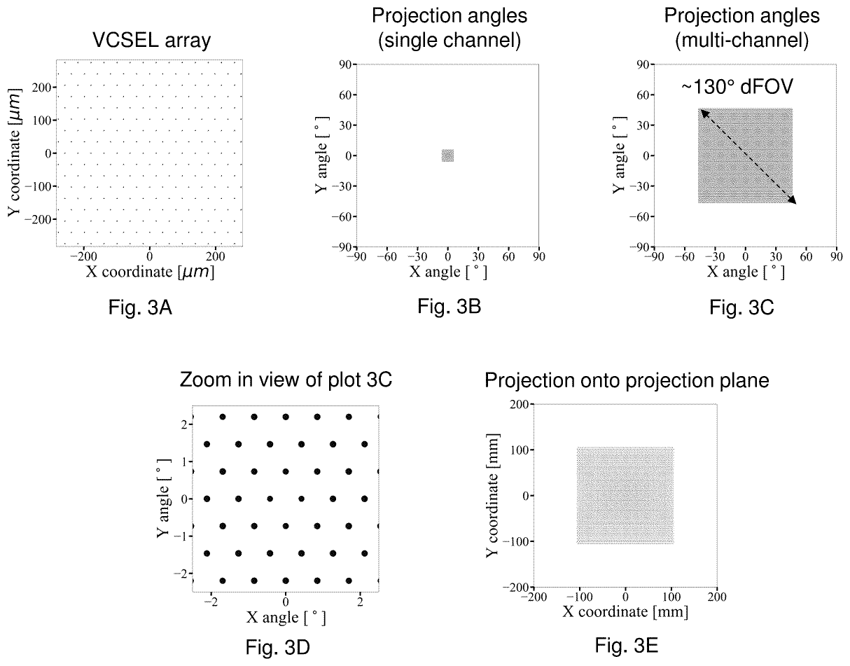

FIGS. 3A-3E show the dot projection properties of a design similar to the one in FIGS. 2A-2D. For an exemplary light emitter array (e.g., a VCSEL (vertical-cavity surface-emitting laser) array) shown in FIG. 3A, the far-field angular distribution of a dot array projected by a single-channel projector (without beam splitting) is shown in FIG. 3B. Each light emitter is collimated and projected by the projector meta-optics and corresponds to a single dot in the far field. For example, when there are M light emitters in the light emitter array, a total of M dots may be formed using a single channel projector. A beam splitting phase profile may be superposed on the beam projection (or lens) phase profile in the flat optics to produce multiple dot arrays and re-direct them to different directions. For example, if the beam splitting phase profile includes N×N different k-vectors, the single-channel projected dot array will be split into N×N channels and an N×N×M dot array may be formed. Each light emitter thereby corresponds to multiple projected dots. FIG. 3C shows the far-field angular distribution of a multi-channel projector with 7×7 k-vectors, generating 49 channels of dot arrays. The FOV of the multi-channel projector is further increased (e.g., by 7 times) compared to the single channel case. A diagonal FOV (dFOV) of approximately 130° is therefore realized in this example. FIG. 3D shows a zoom-in view of FIG. 3C, indicating diffraction limited performance of the collimated beam with full divergence angle less than 0.13 degrees. FIG. 3E shows the spatial intensity distribution of the projected dots at an exemplary projection distance of 100 mm.

By changing the projected beam properties (e.g., divergence, size, intensity pattern, etc.), patterns with varying properties (e.g., throw distance, spot size, intensity distribution) may be generated. By controlling the position, size, density, and/or phase gradients of the entire or sub-regions of the beam splitting phase profile of the flat optics, beam split ratio across different channels, beam sizes, throw distance, and/or deflection angles of each channel may be varied. The k-vectors may also be realized using 1D or 2D diffractive grating type of structures. The diffraction orders generated from the grating may be utilized for beam splitting or re-directing. The flat optics may or may not be positioned in direct contact with the light emitter array.

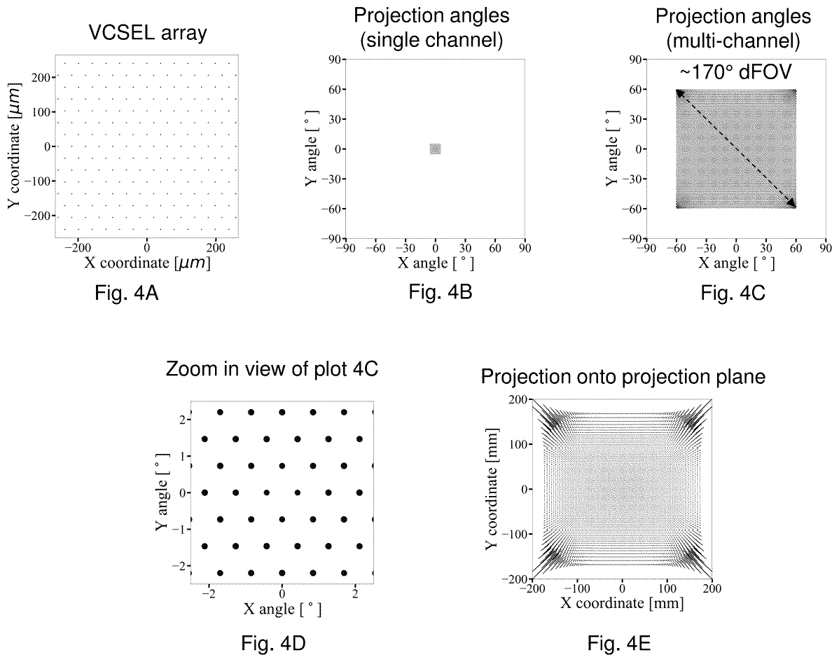

By increasing the number of k-vectors (e.g., in-plane k-vectors or phase gradient patterns), the projected patterns may be further split and deflected to increase the number of dots and entire FOV. For example, as shown in FIGS. 4A-4E, by combining the same single channel projection phase profile with a beam splitting phase profile with 9×9 different k-vectors, the projected dot arrays are split into 81 channels and reach an overall dFOV of approximately 170°.

FIGS. 4A-4E show the dot projection properties of this exemplary design. FIG. 4A shows the exemplary light emitter array (e.g., a VCSEL array). FIG. 4B shows the far-field angular distribution of a dot array projected by a single-channel projector (no beam splitting). Each light emitter corresponds to a single projected dot. FIG. 4C shows the far-field angular distribution of a multi-channel projector. A beam splitting phase profile (e.g., consisting of 9×9 different k-vectors) is superposed on the single-channel beam projection phase profile to produce multiple dot arrays (e.g., 81 channels for each light emitter) and re-direct them to different directions. Each light emitter corresponds to multiple projected dots. The FOV of the multi-channel projector is further increased (e.g., by 9 times) compared to the single channel case. A diagonal FOV of approximately 170° is realized. FIG. 4D is a zoom-in view of FIG. 4C, showing diffraction limited performance of the collimated beam with full divergence angle less than 0.13 degrees. FIG. 4E shows the spatial intensity distribution of the projected dots at 100 mm distance from the projector.

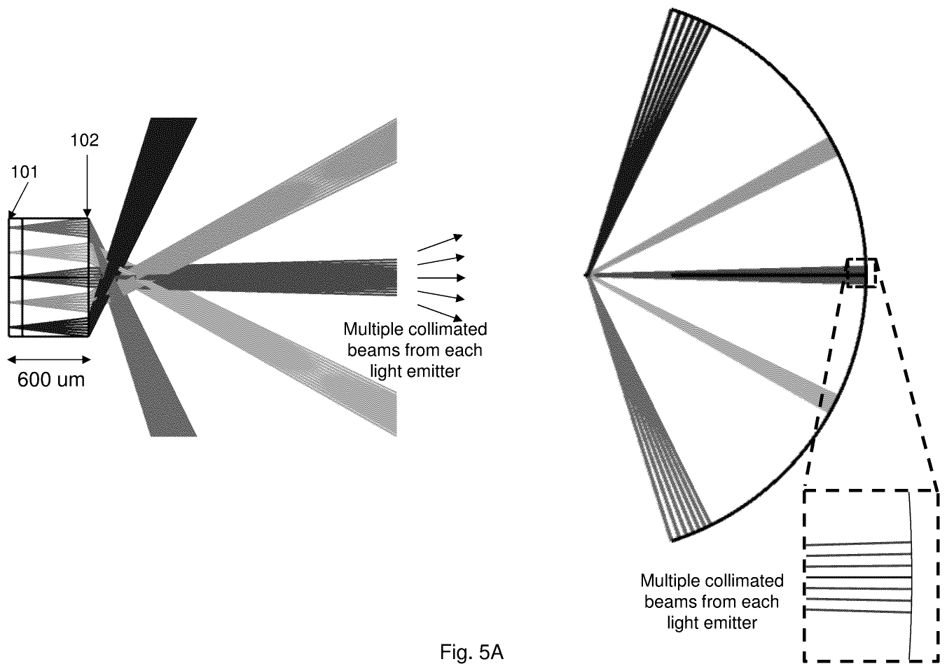

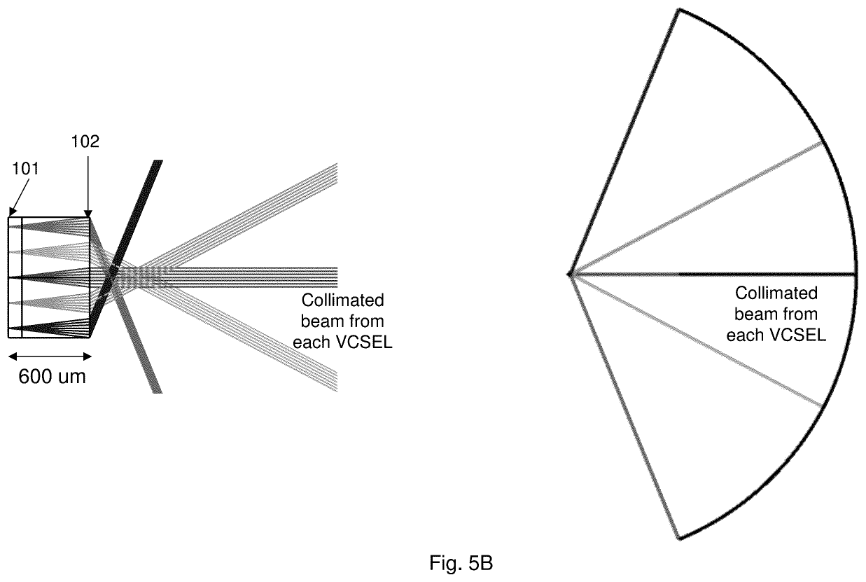

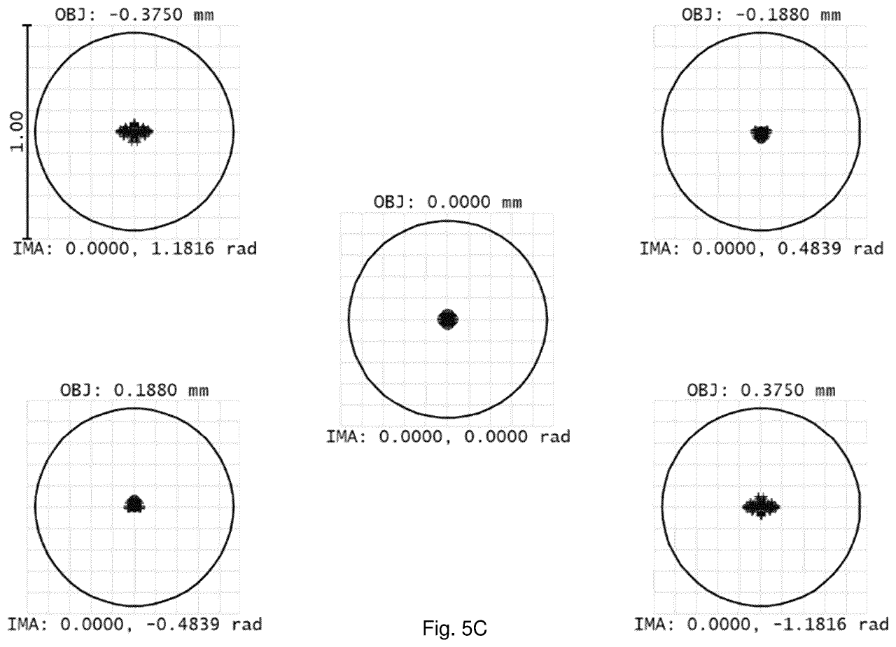

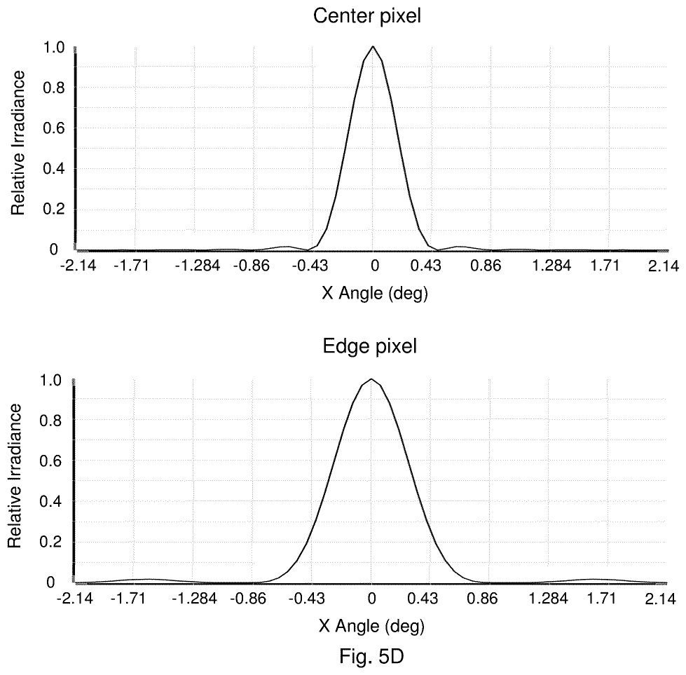

In another example (FIGS. 5A-5D), the flat optics (e.g., a metasurface) contains superposed phase profiles for beam collimation and/or projection (e.g., functioning as a wide-FOV lens) and beam splitting to generate spot array patterns similar to that shown in FIG. 1D. In this case, the deflection angle between each split channels may be smaller than the FOV of a single channel. Furthermore, the flat optics may be positioned in direct contact with the light emitter array. FIG. 5A shows the raytrace simulation of a flat-optics-enabled ultra-compact pattern generation system design with reduced total track length. The flat optics component collimates and projects the light from the light emitters towards different directions and further splits each beam into multiple channels, producing high-density, high quality spot projection. FIG. 5B shows the raytrace simulation of a single channel. In the example, the projected beams from each emitter includes 7×7 collimated beams, as indicated in the zoom-in image of the light rays at the center. FIGS. 5C and 5D show the simulation results indicating diffraction limited beam quality of the collimated beams with divergence angle less than approximately 0.9 degrees. In this example, the system's design wavelength is 940 nm, but other wavelengths may also be chosen.

This optical system may be configured to realize different beam shaping functions, e.g., collimation, focusing, diverging, or other desired intensity and/or phase distributions. The projected optical pattern may be further engineered by controlling the positions or arrangement of the light emitter array, as well as their optical properties (e.g., polarization, wavelength, incident angle, etc.). Additional optical elements (e.g., a flat optics, refractive/reflective optics, micro-lens array, etc.) may be incorporated to further vary the performance and/or functionality.

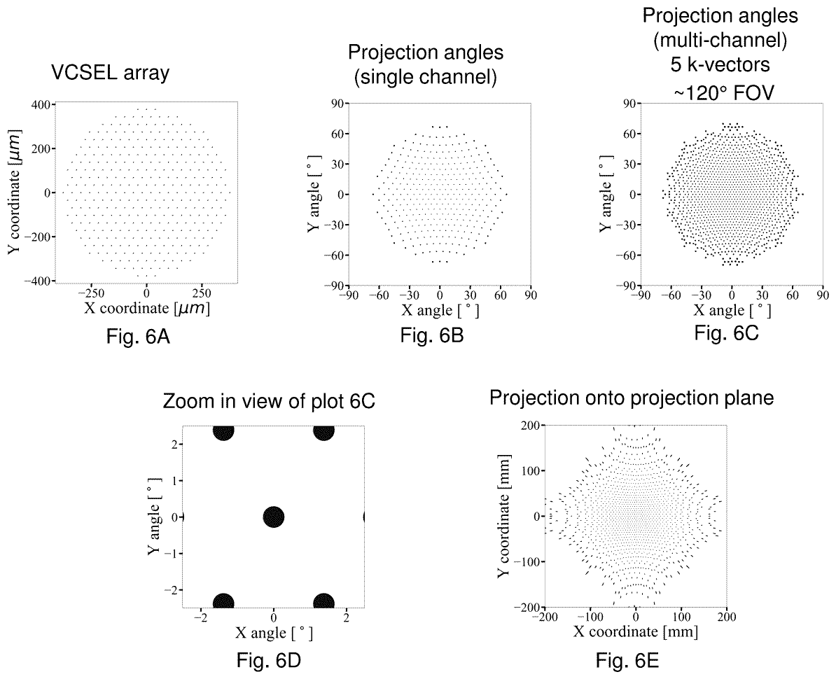

FIGS. 6A-6E show the dot projection properties of a design similar to the one described in FIGS. 5A-5D. For an exemplary light emitter array (e.g., a VCSEL array) shown in FIG. 6A, the far-field angular distribution of a dot array projected by a single-channel projector (without beam splitting) is shown in FIG. 6B. Each light emitter is collimated and projected by the projector flat optics and corresponds to a single dot in the far field. The dFOVs of the single-channel projectors are approximately 120°. With a superposed beam splitting phase profile with 5 k-vectors, FIG. 6C shows the far-field angular distribution of a multi-channel projector, generating 5 channels of projected dot arrays for each light emitter. Each light emitter corresponds to multiple projected dots. In this case, the deflection angle between each split channels may be smaller than the FOV of a single channel. Therefore, the dFOVs of the multi-channel projector are similarly approximately 120°. FIG. 6D shows the zoom-in view of FIG. 6C, indicating diffraction limited performance of the collimated beam with full divergence angle less than approximately 0.9 degrees. FIG. 6E shows the spatial intensity distribution of the projected dots at an exemplary projection distance of 100 mm.

By changing the projected beam properties (e.g., divergence, size, intensity pattern, etc.), patterns with varying properties (e.g., throw distance, spot size, intensity distribution) may be generated. By controlling the position, size, density, and/or phase gradients of the entire or sub-regions of the beam splitting phase profile, beam split ratio across different channels, beam sizes, throw distance, and/or deflection angles of each channel may be varied. The flat optics may or may not be positioned in direct contact with the light emitter array.

The pattern generation systems shown in FIGS. 2A-6E can achieve one-to-one or one-to-multiple correspondence between VCSEL aperture and projected dots. They provide optimal beam quality (i.e. minimal aberration), as well as customizable FOV, projection pattern and channel density.

In another embodiment, the metasurface phase and/or amplitude profile may be designed by superposing additional phase and/or amplitude modulation functions. For example, if one or more beam splitting profile is superposed on the original beam shaping, projection, and/or splitting phase profile, additional channels having more dot arrays can be generated, for example, producing a pattern similar to that shown in FIG. 1E.

In other embodiments, the beam projection and/or splitting meta-optics, when coupled with one or multiple light emitters, may be utilized as an illuminator or diffuser.

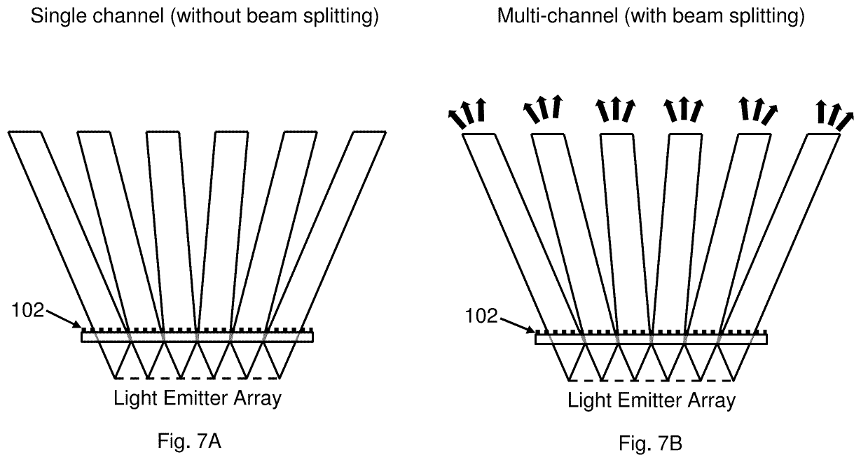

In yet another embodiment, the flat optics may be configured to provide the phase profiles for beam collimation and projection (similar to a micro-lens array function) in which different regions of the flat optics are designated for coupling different light emitters, as schematically illustrated in FIG. 7A. The flat optics may further include a beam splitting phase profile superposed on the micro-lens phase profile to make multiple duplications of the projected pattern to generate multiple spot arrays, as schematically illustrated in FIG. 7B.

The pattern projector, illuminator or diffuser may be paired with an imager formed of flat optics and an image sensor to capture the scene illuminated by the projector. FIG. 8 schematically illustrates such a structured light camera combining a pattern projector that includes a light emitter array 101 and flat optics 102, and an imager that includes another flat optics 104 and a light receiver 105 such as an image sensor coupled to each other. The imager may be designed to capture a portion or the entire scene or only regions of the scene that are illuminated by the pattern projector. Such a structured light camera architecture can be used for 3-D sensing, structured light imaging, Lidar, computing, etc. The projector and imager may be co-designed to enable correspondence between the emitter and image sensor arrays. The imager may be designed to capture regions in the scene that are only illuminated by the pattern projector. The receiving metasurface 104 may also be designed to be sensitive to different properties of the incident light (e.g., polarization, wavelength, incident angle, etc.) so that light with different properties will be redirected to designated detection channels or image sensor regions of the image sensor 105. The flat optics components 102 and 104 of the projector and the imager may be positioned on the same substrate 103 (see FIG. 8) or different substrates (not shown in the drawings). Additional elements (one or an array of them) may also be included and coupled with the imager, e.g., filters (e.g., spectral, polarization, spatial, and/or angular filters), refractive, diffractive, and/or reflective optical elements, light modulators, liquid crystal elements, etc. One example is a pixelated spectral filter array or a single filter coupled with the image sensor. Another example is a pixelated polarization filter array or a single filter coupled with the image sensor.

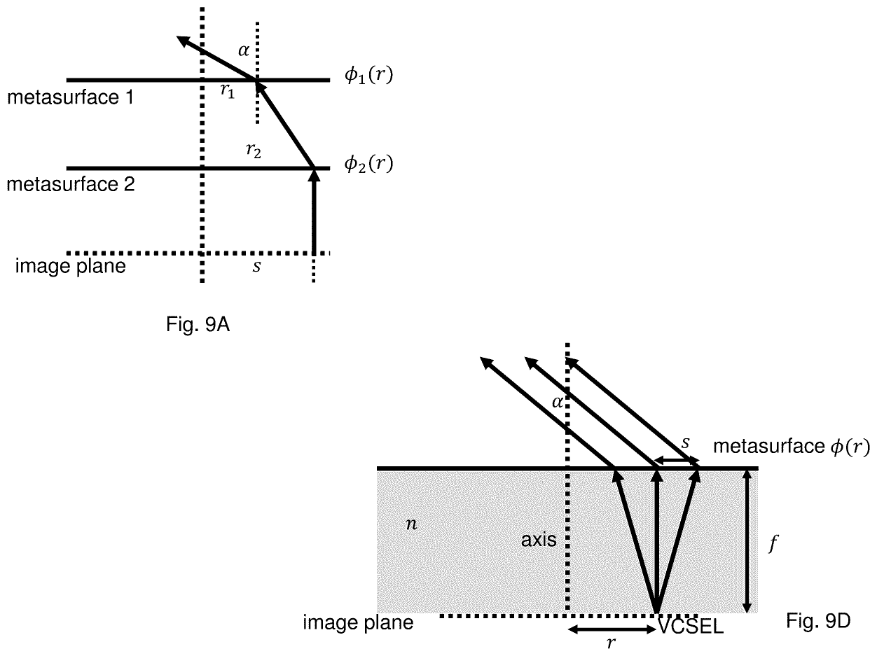

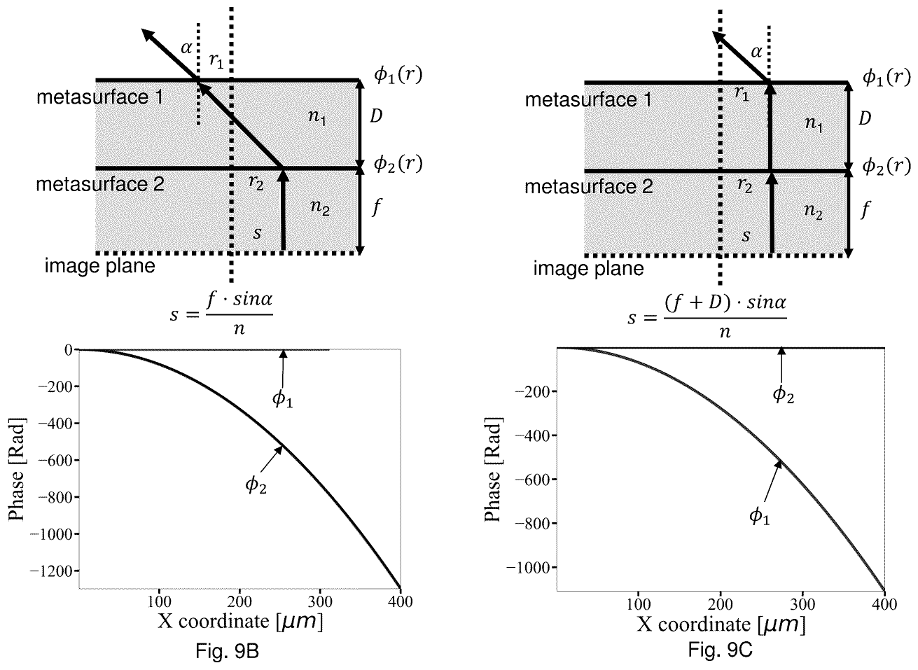

FIG. 9A schematically illustrates a multi-layer flat optics architecture (e.g., a 2-metasurface structure), which may be utilized to provide customized image height to AOI relationship (e.g., minimized distortion) with high imaging performance and large FOVs. Preferably, the two metasurfaces, which are spaced apart from each other in the vertical direction, have identical sizes and coincide in their positions when viewed in the vertical direction. Firstly, the model may be used for designing the single metasurface case by assuming no phase and/or refraction on the first metasurface layer. As an example, FIGS. 9B and 9C show two exemplary designs where one of the two metasurface uses a quadratic phase profile and the other has zero phase. In both cases, the position of the focal spot (or reversely, the light emitter) increases linearly with sin (a), where a is the AOI (or reversely, the projection beam angle).

In FIGS. 9A-9C, n₁ and n₂ denote refractive indices of the two layers of substrate material (between the two metasurfaces, and between the image plane and the second metasurface, respectively); D and f denote the thicknesses of the two substrate layers, respectively; r₁ and r₂ denote positions on the first and second metasurfaces, respectively; and s denotes position on the image plane. ϕ1 and ϕ1 are the phase profiles for the first and second metasurfaces, respectively.

One particular example of the lens phase profile design, for a quadratic phase, is given below with reference to FIG. 9D. The phase gradient at radius r is:

$$\frac{d ϕ ( r )}{dr} = - ( \frac{2 π}{λ} ) \cdot sin [ α ( r ) ] \qquad ( 1 )$$

The ideal phase profile is:

$$ϕ ( r + s ) - ϕ ( r ) = - ( \frac{2 π}{λ} ) \cdot n \cdot ( \sqrt{{f}^{2} + {s}^{2}} - f ) - ( \frac{2 π}{λ} ) \cdot sin [ α ( r ) ] \cdot s \qquad ( 2 )$$

Consider the next VCSEL at position r+δr:

$$ϕ ( r + s ) - ϕ ( r + δ r ) = \qquad ( 3 )$$

$$- ( \frac{2 π}{λ} ) \cdot n \cdot ( \sqrt{{f}^{2} + {( s - δ r )}^{2}} - f ) - ( \frac{2 π}{λ} ) \cdot sin [ α ( r + δ r ) ] \cdot ( s - δ r )$$

Take Eq. (3)-Eq. (2), and using Eq. (1), and assuming s is small:

$$sin ( α ) = \frac{n \cdot r}{\sqrt{{f}^{2} + {s}^{2}}} \to \frac{n \cdot r}{f}$$

This gives the quadratic phase profile:

$$ϕ ( r ) = - ( \frac{2 π}{λ} ) \cdot \frac{n \cdot {r}^{2}}{2 f}$$

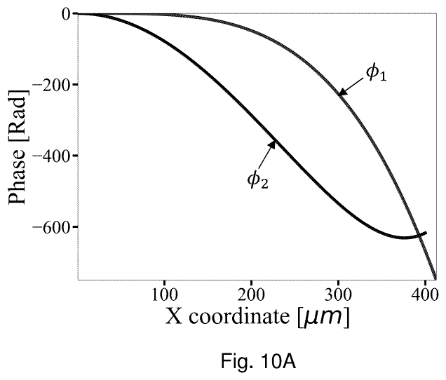

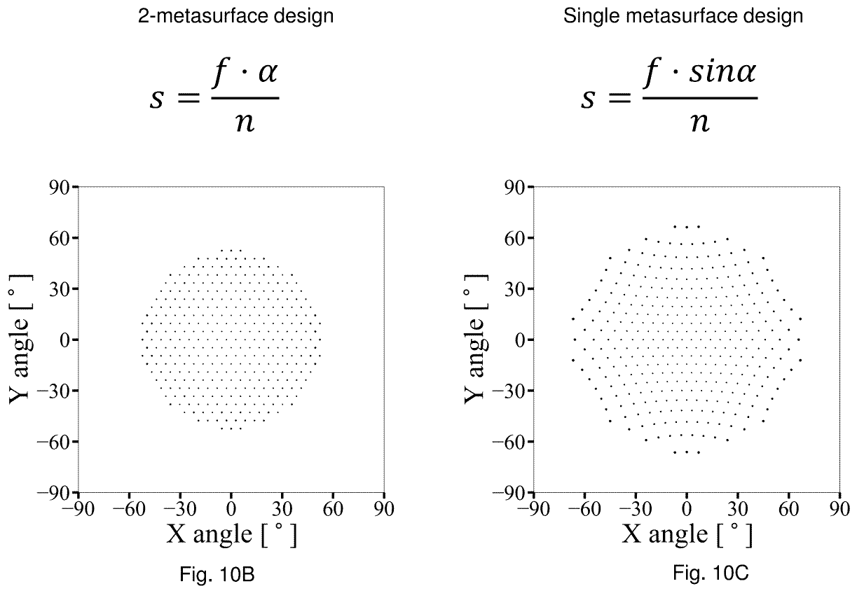

A 2-layer flat optics architecture may be utilized to customize the relations between the image height and AOI (e.g., minimal distortion) while providing high imaging quality. FIG. 10A shows an exemplary design using two phase profiles which produces a linear relation between the image height and AOI (or reversely, light emitter position vs. beam projection angle), i.e., s=f·a/n. FIG. 10B shows the simulated far-field angular distribution of such a projector design assuming light emitter arrays with equally spaced emitters, producing equally distributed, high-quality beams in the angular domain. In comparison, a single metasurface (e.g., using a quadratic phase profile) generates an increasingly distorted pattern as the AOI increases, as shown in FIG. 10C.

Furthermore, one or both of the phase profiles may be superposed with one or multiple beam splitting phase profiles to provide combined light shaping, projecting, and/or splitting functions. Additional optical elements may be used to further improve the performance and introduce new functions.

The multi-layer flat optics design architecture described here can provide concurrent suppression of aberration and distortion, as well as additional beam manipulation functions.

To summarize, flat optics-based optical pattern generation architectures according to embodiments of the present invention employ hybrid meta-optics combining beam projection, splitting, deflection, and/or shaping for optimal performance, using one or multiple optical components. They achieve high beam quality, e.g., near diffraction limit; large field-of-view, e.g., up to 180°; customizable projection pattern and/or channel density in 2D or 3D; illumination patterns that are not limited to dots; and high efficiency compared to DOE elements.

It will be apparent to those skilled in the art that various modification and variations can be made in the flat optics-based optical pattern generation architecture and related method of the present invention without departing from the spirit or scope of the invention. Thus, it is intended that the present invention cover modifications and variations that come within the scope of the appended claims and their equivalents.

1. An optical pattern projection device, comprising:
one or more light emitters; and
a first optical metasurface coupled to the one or more light emitters, configured to project, reshape and/or split light beams generated by the one or more light emitters to generate a projected light pattern, the first metasurface layer containing at least two superposed phase profiles, performing different functions from each other, each of the at least two phase profiles being configured to modulate, collimate, focus, diverge, deflect, shape, split, diffract, or diffuse the light beams from the one or more light emitters.

2. The device of claim 1, further comprising a second optical metasurface spaced apart from the first optical metasurface, the second optical metasurface containing a light shaping and/or projection phase profile configured to modulate, collimate, focus, diverge, diffuse, and/or deflect the light beams from the one or more light emitters, wherein the first and second optical metasurfaces cooperate with each other to produces a defined relationship between light emitter position or light property and corresponding beam projection angle or light property.

3. The device of claim 2, wherein the defined relationship is a linear relationship between light emitter position and beam projection angle.

4. The device of claim 2, wherein the first and second optical metasurfaces have identical sizes.

5. The device of claim 1, wherein at least one of the at least two superposed phase profiles is configured to split or diffract light so as to spatially or angularly distribute the light beam from each of the one or more light emitters into multiple channels.

6. The device of claim 5, comprising a plurality of light emitters, wherein the projected light pattern including a plurality of sub-patterns each corresponding to one of the light emitters.

7. The device of claim 6, wherein in the projected light pattern, the plurality of sub-patterns are identical in shape and are shifted in positions relative to each other, and wherein the plurality of sub-patterns either overlap each other or are non-overlapping with each other.

8. The device of claim 1, wherein the projected light pattern is a 2-D or 3-D pattern including one or more of arrays of dots, lines, matrices, letters, graphics, holograms, random patterns, gray-scale patterns, uniform patterns, and diffusive patterns.

9. The device of claim 1, wherein the projected light pattern reaches a diagonal field of view of approximately 170°.

10. The device of claim 1, further comprising a spacer positioned between the first optical metasurface and the one or more light emitters.

11. The device of claim 1, wherein the first optical metasurface is flat, curved, or conformally integrated with its substrate.

12. The device of claim 1, wherein the one or more light emitters are one or more light sources, one or more optical channels, an image, or a light pattern.

13. The device of claim 1, comprising a plurality of light emitters, wherein the first optical metasurface is configured to provide different responses for different properties of light from the plurality of light emitters, wherein the properties of light are a wavelength, a polarization, an angle-of-incidence, or an intensity of the light beam.

14. The device of claim 1, wherein the light emitter or plurality of light emitters are configured to emit light beams with same or different properties of light, wherein the properties of light are a wavelength, a polarization, a beam divergence, or an order.

15. An optical pattern projection and detection device comprising the optical pattern projection device of claim 1, further comprising an optical pattern detection device which includes:
another optical metasurface configured to modulate, shape, collimate, focus, diverge, deflect, split, diffract, or diffuse the light beams; and
one or multiple light receivers coupled to the other optical metasurface.

16. The device of claim 15, wherein the first optical metasurface and the other optical metasurface are formed on separate, partially overlapping, or fully overlapping portions of a same substrate.

17. The device of claim 15, wherein the light receiver includes photodetectors or optical channels.

18. An optical pattern projection device, comprising:
a light emitter array including a plurality of light emitters; and
one or more flat optics layers, configured to project and split light beams generated by the plurality of light emitters to generate a projected light pattern, the projected light pattern including a plurality of sub-patterns each corresponding to one of the light emitters, wherein the sub-patterns are identical in shape, are shifted in position relative to each other, and overlap each other.

19. An optical pattern projection and detection device comprising the optical pattern projection device of claim 18, further comprising an optical pattern detection device which includes:
another flat optics layer configured to modulate, shape, collimate, focus, diverge, deflect, split, diffract, or diffuse the light beams; and
a light receiver coupled to the other flat optics layer.

20. An optical pattern projection device, comprising:
a light emitter array including a plurality of light emitters; and
a flat optics layer coupled to the light emitter array, configured to project, reshape and/or split light beams generated by the plurality of light emitters to generate a projected light pattern, the projected light pattern including a plurality of sub-patterns each corresponding to one of the light emitters, wherein the flat optics layer includes superposed phase profiles, including a phase profile for beam collimation and projection in which different regions of the flat optics are configured for coupling light beams from different light emitters, and a beam splitting phase profile configured to spatially distribute the light beam from each light emitter into multiple channels.

21. An optical pattern projection and detection device comprising the optical pattern projection device of claim 20, further comprising an optical pattern detection device which includes:
another flat optics layer configured to modulate, shape, collimate, focus, diverge, deflect, split, diffract, or diffuse the light beams; and
a light receiver coupled to the other flat optics layer.

22.-39. (canceled)
